(19) United States
(12) Patent Application Publication
(10) Pub. No.: US 2013/0071030 A1
(43) Pub. Date: Mar. 21, 2013

(54) METHOD FOR GRAPHOLOGY-BASED ASSESSMENT OF PERSONALITY TRAITS OF A SUBJECT USING INFERRED HANDWRITING FEATURES DERIVED FROM THE SUBJECT'S PRESENTATION FEATURES

(71) Applicant: Michael Scott Weitzman, West Islip, NY (US)

(72) Inventor: Michael Scott Weitzman, West Islip, NY (US)

(21) Appl. No.: 13/236,785

(22) Filed: Sep. 20, 2011

(51) Int. Cl. G06K 9/00

(52) U.S. Cl. 382/187

(57) ABSTRACT

A method for graphology-based assessment of a subject's personality traits is disclosed which involves graphological analysis of inferred handwriting features that are derived from the subject's presentation features. The method includes: obtaining presentation features of a subject; deriving inferred handwriting features of the subject from the presentation features according to pre-determined rules of correlation between the presentation features and the inferred handwriting features; and then performing graphological analysis on the inferred handwriting features so as to provide an assessment of the subject's personality traits. Presentation features can include a subject's general appearance, attire, body language, facial expression, and/or conversational style, for example. Handwriting features can include zonal sizes, connective forms, the handwriting's pressure, spacing, size, and slant, level of script, primary and secondary variables, and/or overall form level data.

### FIELD

The invention relates generally to assessment personality traits, and more particularly to graphology-based assessment of personality traits.

### BACKGROUND

Graphology (also known as handwriting analysis, or graphological analysis) is the study and analysis of an individual's handwriting. Graphology can be used to evaluate an individual's personality.

An individual's handwriting is analyzed with respect to certain “handwriting features” that are determined to be useful in handwriting analysis. Such handwriting features can include, but need not be limited to, the use of space, the size of the handwriting, zonal sizes in the writing, letter slant, connective forms, pressure applied in the handwriting, the usage of print versus script, and/or specific letter formations, to name only a few examples.

Handwriting features of an individual's handwriting can shed light on various traits of that individual's personality, such as aspects of their social behavior and/or level of honesty, for example. However, graphological analysis does not always provide a full picture of an individual's personality.

For instance, an amateur or inexperienced graphologist may miss some personality traits when using only graphology. Moreover, even an experienced graphologist capable of gleaning a great deal of information from a handwriting sample, may not have access to a handwriting sample of sufficient length or comprehensiveness as to provide the graphologist with all the information regarding a subject's handwriting useful for fully and/or accurately determining the subject's personality traits.

Furthermore, in some cases an individual may be inadequately represented, or even misrepresented, by his or her handwriting. Consequently, insight into an individual's personality traits obtained from even the most comprehensive handwriting sample may be lacking in certain areas. As a result, certain personality traits simply may not be detectable through analyzing only the subject's handwriting. For example, a sample provided by a subject who has purposely manipulated, or even subconsciously altered, their handwriting away from their natural form of expression, may not accurately present certain handwriting features indicative of their true personality traits.

Therefore, despite the wide variety of handwriting variables typically analyzed in the field of graphology, graphology can sometimes present less than a full picture of an individual's personality traits, due to inexperienced graphological analysts, limited access to comprehensive handwriting data, and/or handwriting that does not fully accurately represent an individual's true personality traits.

### SUMMARY

A method for graphology-based assessment of a subject's personality traits is claimed. By using an individual's presentation features to infer the handwriting features that represent that individual's personality, subsequent graphological analysis can be rendered more accurate and comprehensive. Drawing upon presentation features can help graphology to identify an individual's personality traits.

The method of the present invention enables graphologists to deduce inferred handwriting features from presentation features, where the inferred handwriting features provide data that is more comprehensive and/or more accurate than data solely available through actual handwriting features obtained from a real handwriting sample.

Therefore, inferred handwriting features derived from presentation features lead to a fuller understanding of an individual's personality than can be obtained solely by analyzing a real handwriting sample. The inferred handwriting features fill in gaps caused by a handwriting sample of insufficient length or comprehensiveness, and/or they shed more light on a handwriting sample that may otherwise be misinterpreted by amateur graphologists.

Finally, the inferred handwriting features represent a subject more accurately than just actual handwriting features extracted from a real handwriting sample, particularly where the real handwriting sample is written by a subject who consciously or subconsciously altered their natural approach to handwriting.

In one general aspect, the invention is a method for graphology-based assessment of personality traits of a subject. The method includes: obtaining presentation features of the subject; deriving inferred handwriting features from the presentation features according to pre-determined rules of correlation between the presentation features and the inferred handwriting features; and performing graphological analysis on the inferred handwriting features so as to provide an assessment of the subject's personality traits.

In some embodiments, obtaining presentation features includes observing at least one of: the subject's general appearance; the subject's personal attire; the subject's hair style; the subject's body language; the subject's facial expression; the subject's handshake; the subject's conversational tone; and the subject's conversational style. In some embodiments, obtaining presentation features includes: observing an upper zone of the subject's body; observing a middle zone of the subject's body; and observing a lower zone of the subject's body.

In some embodiments, deriving inferred handwriting features from the presentation features includes mapping information regarding at least one of upper, middle, and lower zones from the presentation features, to at least one of corresponding upper, middle, and lower zones of the inferred handwriting features being derived from the presentation features.

In some embodiments, deriving inferred handwriting features includes deriving from the presentation features at least one of primary variables and secondary variables. In some embodiments, the primary variables include: zonal sizes of handwriting; connective forms of handwriting including garlands, arcades, angles, and threads; and pressure applied during handwriting. In some embodiments, the secondary variables include: spacing of writing; size of writing; slant of writing; and level of script.

In some embodiments, performing graphological analysis on the inferred handwriting features so as to provide an assessment of the subject's personality traits includes: determining handwriting form level based upon the inferred handwriting features.

In another general aspect, the method for graphology-based assessment of personality traits of a subject includes: obtaining presentation features of the subject; deriving inferred handwriting features from the presentation features, according to pre-determined rules of correlation between the presentation features and the inferred handwriting features; identifying actual handwriting features from a real sample of the subject's handwriting; and performing graphological analysis on: the inferred handwriting features; and the actual handwriting features, so as to provide an assessment of the subject's personality traits.

In some embodiments, obtaining presentation features includes observing at least one of: the subject's general appearance; the subject's personal attire; the subject's hair style; the subject's body language; the subject's facial expression; the subject's handshake; the subject's conversational tone; and the subject's conversational style. In some embodiments, obtaining presentation features includes: observing an upper zone of the subject's body; observing a middle zone of the subject's body; and observing a lower zone of the subject's body.

In some embodiments, deriving inferred handwriting features from the presentation features includes mapping information regarding at least one of upper, middle, and lower zones from the presentation features, to at least one of corresponding upper, middle, and lower zones of the inferred handwriting features being derived from the presentation features.

In some embodiments, deriving inferred handwriting features includes deriving from the presentation features at least one of primary variables and secondary variables. In some embodiments, the primary variables include: zonal sizes of handwriting; connective forms of handwriting including garlands, arcades, angles, and threads; and pressure applied during handwriting. In some embodiments, the secondary variables include: spacing of writing; size of writing; slant of writing; and level of script.

In some embodiments, performing graphological analysis on: the inferred handwriting features; and the actual handwriting features, so as to provide an assessment of the subject's personality traits, includes: determining handwriting form level based upon the inferred handwriting features.

### BRIEF DESCRIPTION OF THE DRAWINGS

The invention will be more fully understood by reference to the detailed description, in conjunction with the following figures, wherein:

FIG. 1 is a perspective view of two individuals interacting, wherein each individual is exhibiting presentation features that can be used to infer handwriting features, according to pre-determined rules of correlation;

FIG. 2 is an input-output diagram showing the derivation of inferred handwriting features from presentation features in accordance with an embodiment of the invention;

FIG. 3 is a perspective view of an individual exhibiting various presentation features that can be used to infer handwriting features, according to pre-determined rules of correlation between presentation features and handwriting features;

FIG. 4 is a handwriting sample of the individual represented in FIG. 3;

FIG. 5A is a chart displaying sample presentation features, sample primary variable handwriting features which are inferred from the presentation features, and sample personality traits indicated by the inferred primary variable handwriting features;

FIG. 5B is a chart displaying sample presentation features, sample secondary variable handwriting features which are inferred from the presentation features, and sample personality traits indicated by the handwriting features by the inferred secondary variable handwriting features;

FIG. 6 is a chart depicting the relationship between handwriting features and the general form level of an individual's handwriting, which can impact how particular handwriting features of the individual may be interpreted;

FIG. 7 is a chart displaying handwriting features relevant to an individual's handwriting form level, presentation features correlated to the relevant handwriting features, and personality traits implied by the relevant handwriting features, in accordance with an embodiment of the present invention; and

FIG. 8 is a flowchart depicting the steps to assess an individual's personality traits, in accordance with an embodiment of the present invention.

### DETAILED DESCRIPTION OF PREFERRED EMBODIMENTS

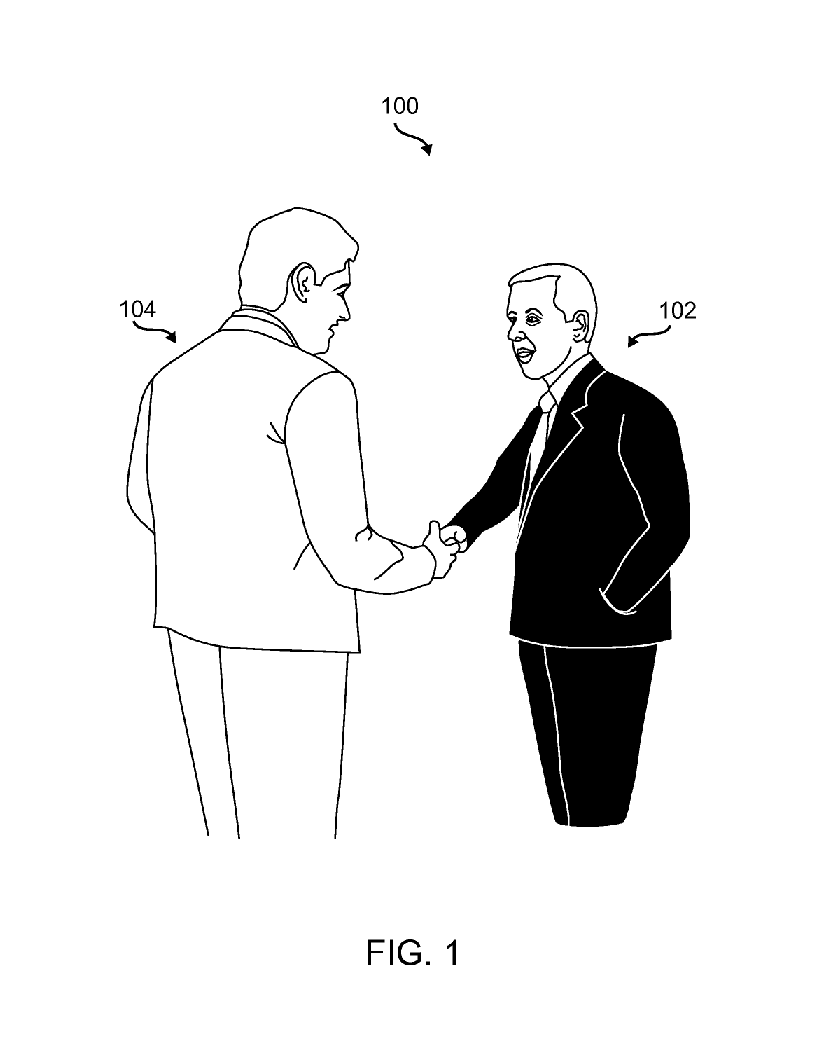

Referring now to the drawings and in particular to FIG. 1, number 100 identifies a scene containing two individuals 102 and 104. The two individuals 102 and 104 are shown in a typical greeting scenario in which both individuals 102 and 104 are shaking each others hand. Various features or traits of each individual 102 and 104 can be analyzed, determined, or observed from the scene 100. For example, such features may include body language of either individual 102 or 104, conversational tone, conversational style, posture, physical traits such as height, weight, hair color, facial expression, stance, hand grip, style of clothing, tightness of clothing, and color of clothing. As will be explained more fully herein, such personal presentation features may be used in combination with handwriting features to develop a personality assessment of either of the individuals 102 or 104.

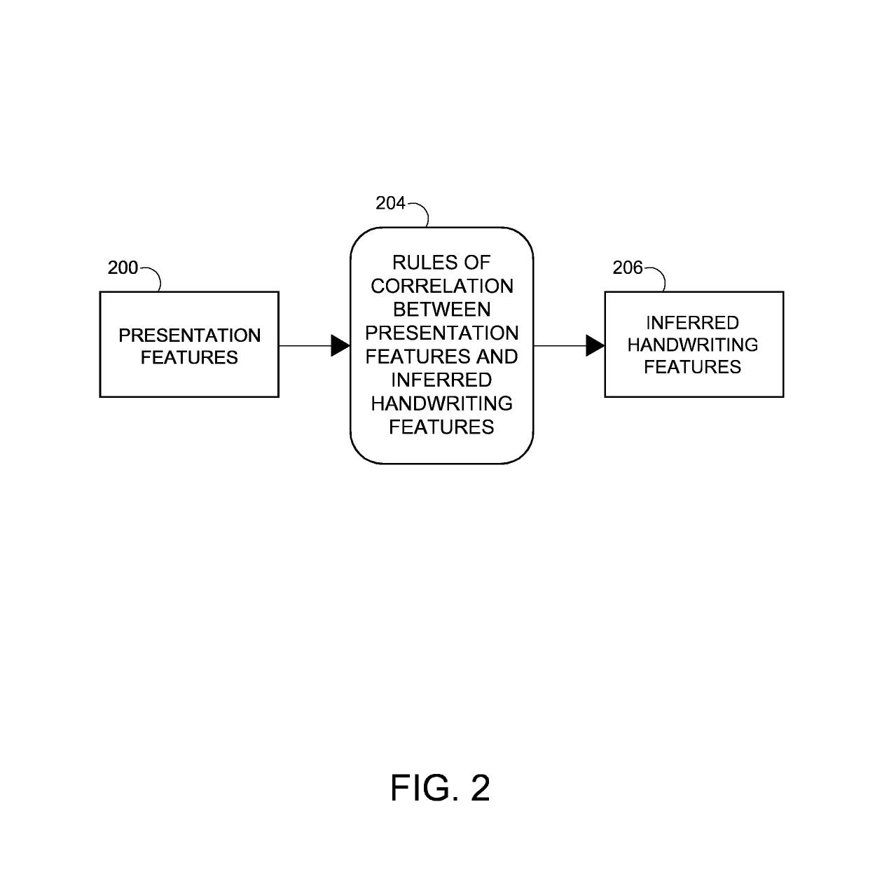

FIG. 2 illustrates a flowchart 200 depicting the steps taken to assess the personality of an individual, such as the individual 102 or 104, by use of a combination of personal presentation features and handwriting features. The flowchart 200 shows a first step 202 in which personal presentation features of an individual are determined. In a next step 204, rules of correlation between personal presentation features and handwriting features are employed. In a step 206, inferred handwriting features for an individual are determined. In this manner, by the use of the combination of personal presentation features and handwriting features an enhanced assessment of an individual may be prepared or generated. Further, by use of a combination of personal presentation features and handwriting features, more personality traits may be detected than if only handwriting analysis is performed or used.

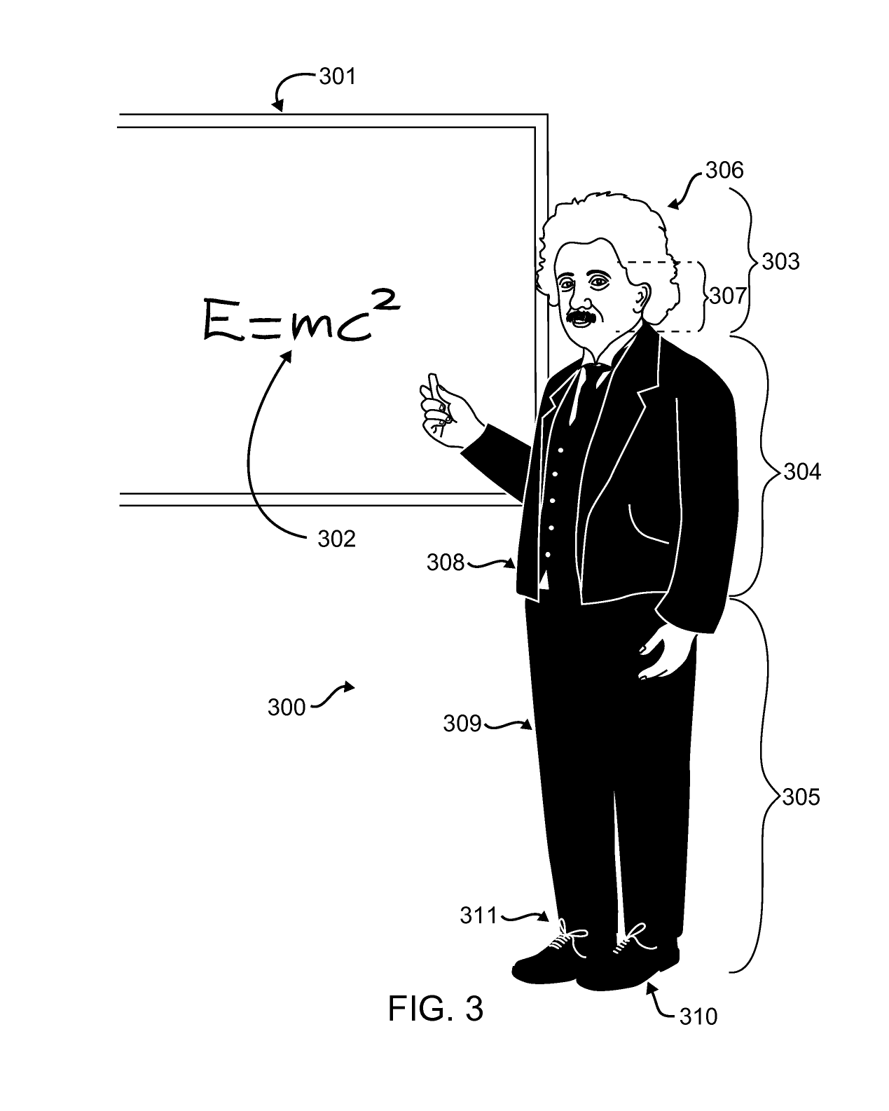

With reference now to FIG. 3, an illustration of an individual 300, such as by way of example only the individual 300 being Albert Einstein, is shown in which the individual 300 is performing a presentation and various features of the individual are being observed, obtained, or determined. The individual 300 is shown having three major zones or body portions that can be viewed to determine various personality traits. The major body portions are an upper zone, a middle zone, and a lower zone. The upper zone encompasses the head in general 302 (including the hair 304), as well as the face 306 in particular. The middle zone includes the torso of the individual's body 308, down to (but not below) the waist. The lower zone includes the lower portion of the individual's body 308 below the waist, including the legs as well as the feet 312. As can be appreciated, when assessing presentation features of the individual 300, the three major zones are observed.

For example, in the upper zone the head 302 is viewed to determine such features as hair length, hair color, head position, and head movement. Wild and tousled hair 304 correlates to a dominant upper zone, which correlates to the personality traits including deep thinking, creativity, planning, innovation and inventiveness. Facial expression (stern, firm, steady unwavering) shown by the face 306 correlates to dominant heavy pressure pattern, angles (remember: most people with heavy pressure will also have angles, resulting in similarities), and long/heavy t-bar crossings which all correlate to the personality traits including strength of character, determination, motivation, persistence, and drive. In the middle zone such features as clothing color, clothing looseness or tightness, general posture and body stance may be viewed. Einstein's plain attire (which is dark, blends in, and is not loud and doesn't stand out) indicates a fluctuating middle zone and leftward tendencies, both of which correlate to such personality traits as being reserved and introverted. In regards to the fluctuating middle zone alone, the individual 300 will follow respectful trends, but will not strictly follow current trends to be fashionable and gain social acceptance. In particular, Albert Einstein was known to have about seven pairs of the same color and type suit. Posture (slight droop) displayed in the middle zone correlates to the fluctuating middle zone and leftward tendencies, which both correlate to the same personality traits discussed with respect to attire regarding reserved and introverted. The lower zone may be used to view the attire of the legs, type of shoes worn, and color of shoes worn. Einstein's shoes 310 (dark) correlate to the same handwriting features and personality traits discussed with respect to attire regarding being reserved and introverted. Shoelaces tight correlates to the dominant heavy pressure pattern, which correlates to the same personality traits discussed with respect to facial expression. Big loops in the shoelaces 312 correlate to a dominant upper zone, which correlates to the same personality traits discussed in connection with wild and tousled hair. Also, double knots in the shoelaces correlate to angles, which correlate to the same personality traits discussed in connection with facial expression. Further, other personal presentation features of the individual 300 may be observed such as the conversational style of the individual 300 and conversational tone of the individual 300. Such listed personal presentation features are for purposes of example only and there are numerous other personal presentation features that may be employed.

An amateur or inexperienced analyst may miss certain personality traits when viewing the individual's 300, Einstein's, presentation depicted in FIG. 3. The degree to which Einstein is focused on the here and now, is realistic, objective, and socially aware may be missed. These personality traits that an analyst may miss maps to the handwriting variable middle zone and can be seen in Einstein's handwriting with Einstein having a developed middle zone, underdeveloped middle zone, or fluctuating middle zone. The analyst may miss the presentational characteristic in Einstein because Einstein has a fluctuating middle zone combined with a non-dominant middle zone trait as well (his attire, clothes, body language, appearance, and any other presentational characteristics will not strictly follow current trends because he is a leader, innovator, and someone who does not need the approval of other people as a writer with a dominant middle zone who dress, act, and behave strictly based on those trends). Items such as shaking hands and looking someone in their eyes as a current trend are not being referred to here. Einstein's presentational characteristics will be according to his own tastes and not based on other people's perceptions, but may be missed due to him following standards for presentation (example: formal is to a suit).

The degree to which Einstein is energetic, enjoys physical activities, and has the stamina to maintain a driving force to accomplish tasks may be missed. These personality traits that an analyst may miss maps to the handwriting variable lower zone and can be seen in Einstein's handwriting with Einstein having a developed lower zone, underdeveloped lower zone, or a fluctuating lower zone. The analyst may miss this presentational characteristic in Einstein because he has a developed lower zone that is non-dominant in nature (all dominant traits will stand out in the person's presentational characteristics). Because he has a developed lower zone that is non-dominant in nature, the analyst may miss the presentational characteristics leading to this conclusion. His presentational characteristics referring to this trait will be blended in his appearance, but will be seen by analyzing the amount of energy, passion, and driving force there is to his personality by the way he speaks and acts.

The degree, to which Einstein is comfortable around other people, particularly relating to the vicinity of being around other people and not involving direct communication interactions with others may be missed by an analyst. These personality traits that an analyst may miss maps to the handwriting variable use of space variable and can be seen in Einstein's handwriting with him having wide or narrow letter spacing, wide or narrow word spacing, and wide or narrow line spacing or any combinations of inconsistencies (margins are left out here). Further, these personality traits that an analyst may miss maps to the handwriting variable use of space variable and can be seen in Einstein's handwriting with him having wide or narrow letter spacing, wide or narrow word spacing, and wide or narrow line spacing or any combinations of inconsistencies (margins are left out here). The analyst may miss this presentational characteristic in Einstein because he has fairly wide letter spacing, and narrow word and line spacing (all non-dominant and all revealing a desire and comfort being around other people relating to vicinity). The analyst will most likely come to the conclusion that Einstein is more introverted and extroverted by the sum of the other variables, but regarding his comfort zone relating to being around other people, particularly in the vicinity of others (examples include urban, suburban, or rural environments, amount of clubs and organizations joined and actively part of), he likes to be around people and prefers a suburban or an urban environment and will partake in clubs and organizations. In regards to him being more introverted and missing this presentational characteristic, his attire, body language, and other characteristics will point to an introverted nature and possibly not being comfortable around others, however, this will be seen when he is around other people and how comfortable he is around other people plus amount of clubs and organizations joined.

An amateur or inexperienced analyst may not miss the following personality traits when viewing the individual's 300, Einstein's, presentation illustrated in FIG. 3. The degree to which Einstein is a deep thinker, creative, inventive, and an innovator may not be missed. These personality traits map to the handwriting variable upper zone and can be seen by him having a dominant upper zone, developed upper zone, or a undeveloped upper zone. The analyst may not miss this presentational characteristic in Einstein because he has a dominant upper zone seen by his somewhat unorganized and wild hair style. If Einstein had a developed upper zone or an underdeveloped upper zone, an analyst would have to assess this variable according to the person's preference to conversation (interests in philosophy and inventions (upper zone), interests in reality TV shows (middle zone), interests in sports (lower zone)). An analyst would also know the upper zone is dominant not just by the hair style but by his preference to conversation as well.

The degree to which Einstein is focused, determined, and motivated and also very creative, objective, and pragmatic (last segment already seen in handwriting) are other traits that might not be missed by an analyst. These personality traits map to the handwriting variable threads with angular connective forms and can be seen by the degree of threads with angular connective forms (dominant). The analyst may not miss this presentational characteristic in Einstein because he has dominant threaded handwriting with angular connective forms; the angular connective forms can be seen by his double knotted shoelaces, firm look about his eyes, disciplined appearance.

Other personality traits that may not be missed by an analyst are the degree to which Einstein is more introverted or extroverted. These personality traits map to the handwriting variable space, size, slant, cursive, or printed, and specific letter formations and can be seen by the accumulation of results from these variables. The analyst may not miss this presentational characteristic in Einstein because in comparison to extroverted characteristics, there are so many more introverted traits seen in the following discussion that point to a more introverted nature. For example, introversion can be seen by the following: mixture of dark and light colors (all subtle and not vibrant); many other subtle features about his appearance (except upper zone because that is where he wants society to notice and accept and remember him for; everybody wants others to perceive them in a certain way and he wants to be perceived as a genius and very smart man); more subtle facial expressions; more than a double knot on shoelaces; and tight knot in shoelaces. While extroversion can be seen by the following: upper zone features stand out and call attention; and gives eye contact.

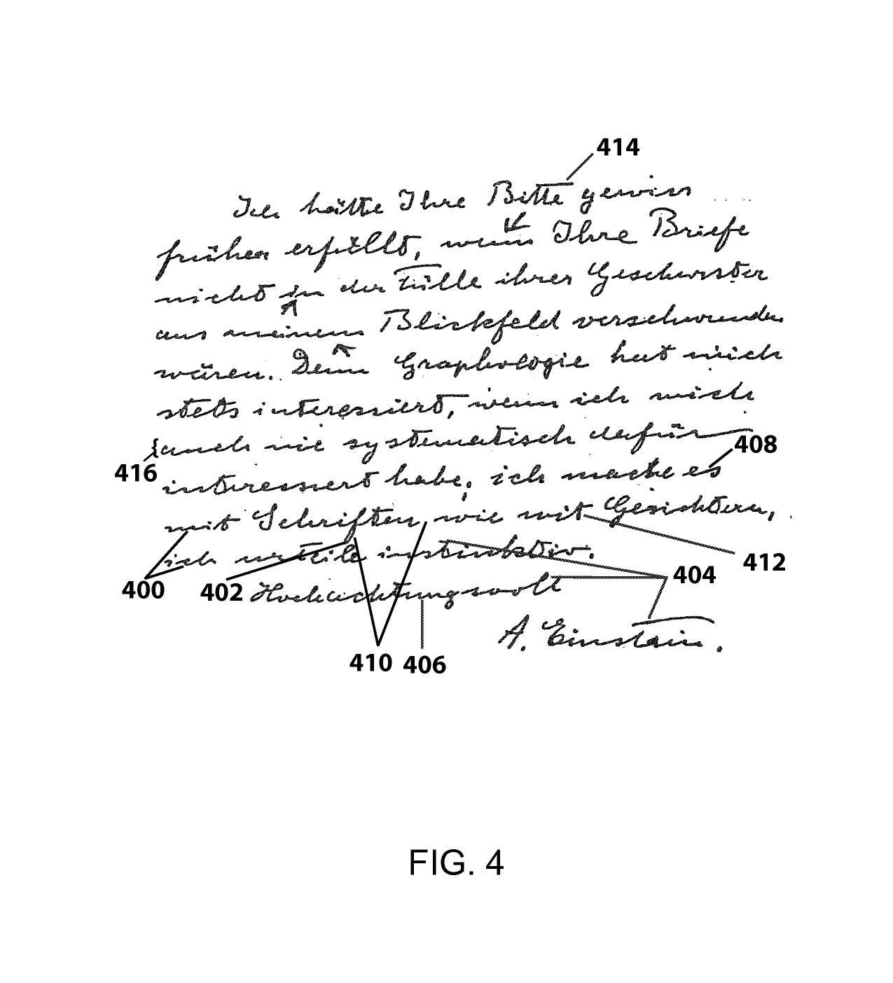

FIG. 4 is a handwriting sample produced by an individual, such as again by way of example only Albert Einstein, for analysis of the personality of the individual in accordance with an embodiment of the present disclosure. Handwriting is made up of three zones or cases, namely, upper zone, middle zone, and lower zone. The handwriting sample includes various features which may be used to determine or reveal personality traits of the individual. The handwriting sample of the individual shown in FIG. 4 includes instances of the following features: fluctuating middle zone emphasis 400; fairly developed lower zone 402; dominant upper zone emphasis 404; dominant threads with angles 406; fairly wide letter spacing 408; narrow word and line spacing 410; leftward tendencies including compressions, retracing, and rigidness 412; strong t-bar crossings 414; and size 416. There are various other features of handwriting that have not been illustrated. Such other features may include but are not limited to handwriting having narrow lines, a vertical slant, an extreme rightward slant, leftward tendencies (such as compression; retracing; and rigidness), rightward tendencies (including slight loss of legibility), tent-like structures in letters “t” and “d”, connected i-dots, t-bar crossings to the right of the t-stem, page margins, and pressure.

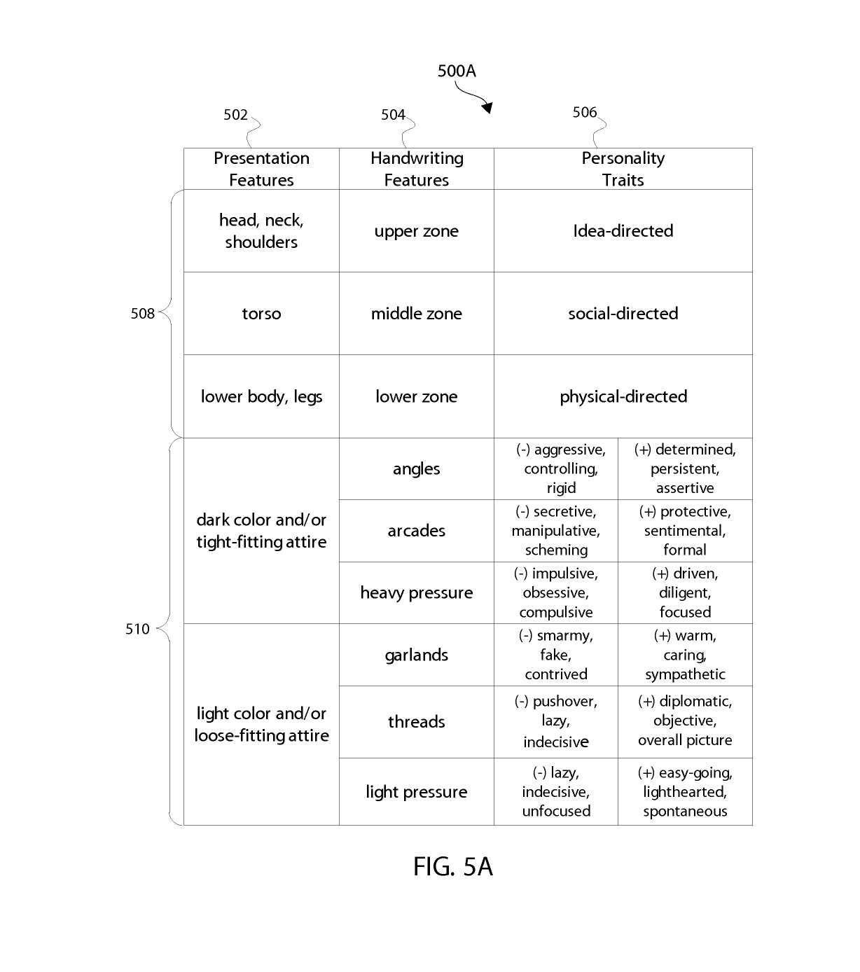

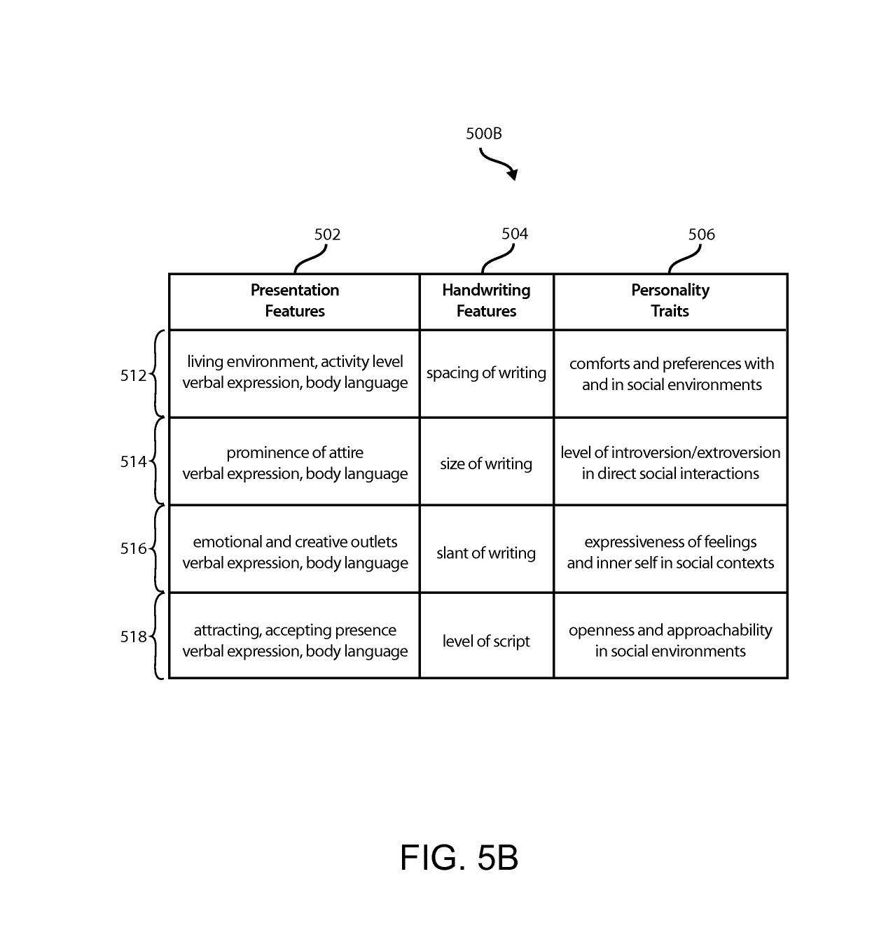

Referring now to FIG. 5A, a list 500A is shown of sample presentation features 502 and handwriting features 504 are categorized and associated or correlated with various personality traits 506. The list 500A is an example of predetermined rules of correlation between personal presentation features and handwriting features. The top three rows 508 of the list 500A identify the top three presentation features 502 and handwriting features 504. The top three presentation features 502 are the upper portions of the body such as head, neck, shoulders, the middle portion or torso of the body, and the lower portion such as the lower body and legs. The top three handwriting features 506 are the zonal size features of handwriting such as the upper zone, the middle zone, and the lower zone. The list 500A also identifies other presentation features 502 and handwriting features 504 in the rows 510. The other presentation features 502 in the rows 510 are related to clothing choices such as clothing color and/or looseness or tightness of the fitting of the clothing. The other handwriting features 504 in the rows 510 are related to other handwriting features, such as in the connection of one letter to an adjacent letter and handwriting pressure. The presentation features 502 and the handwriting features 504 in the rows 508 and 510 are categorized as primary variables.

The rows 508 of the handwriting features 504 represent the size of certain zones of letters relative to the size of the rest of the letter, and in particular: the size of the upper, middle, and lower zone of a letter relative to the entire letter. These zones relate to the upper, middle, or lower third of the extended space that a letter potentially fills, respectively. A size of 3 mm for each of the individual zones is generally taken as the standard, with an overall 9 mm as the standard of size for handwriting. As known to those skilled in the art, the upper zone is that portion of the handwriting that includes the upper portions of the tall letters with “extender” portions that extend vertically, such as the letters b, d, f, h, k, l, and t. The lower zone includes the lower portions of letters with “descenders,” such as the letters f, g, j, p, q, y, and z. The middle zone includes the middle portions of extended letters, or in their entirety letters which do not extend up or down, such as, for example, a, e, r, m and c. As can be appreciated the handwriting features are not limited to handwritten English. The methods of handwriting analysis for personality assessment as described herein can also be applied to other languages, for example, French and Spanish (both of which use a cedilla), Greek, and non-Western languages.

The presentation features 502 and the handwriting features 504 in rows 508 provide information regarding the focus of a subject's inner thoughts and their inner needs, desires, hopes and dreams. Any given zone (upper, middle, or lower) of the letters of the handwriting of an individual can be “undeveloped,” or “developed.” Also, the presentation features of an individual can be “undeveloped” or “developed.” Zones can be expressed dominantly as well. The upper body portion and the upper zone relate to an individual's thoughts and their inner mental world. The torso and the middle zone relate to an individual's social world, the here and now, and the fitting in with trends and people. The lower body portion and the lower zone relates to carnal energy, physical and body energy, and subconscious and unconscious drive. Someone with a developed body portion and developed zone is involved in the respective sphere of existence associated with that zone, whereas someone with an undeveloped body portion or undeveloped zone is less than fully involved in the dimension of life related to that zone. A dominant body portion or zone indicates a habitual and consistent connection to the dimension of life corresponding to that zone.

The connective forms listed in the rows 510 of the handwriting features 504 are garlands, threads, angles, and arcades. The connective forms are indicative of how an individual relates to people, and how the individual expresses themselves in relation to pursuing their goals. Garlands are connective forms that are curved at the bottom and open at the top, like a cup, for example. Arcades, in contrast, are connective forms that are curved on top and open at the bottom, like an arch. Angles include abrupt changes in direction. Threads are squiggle-shaped connective forms that look like a mixture of garlands and arcades. Threads can sometimes be sinuous, thinning, or diminishing, which can lead them to be interpreted more negatively in certain contexts.

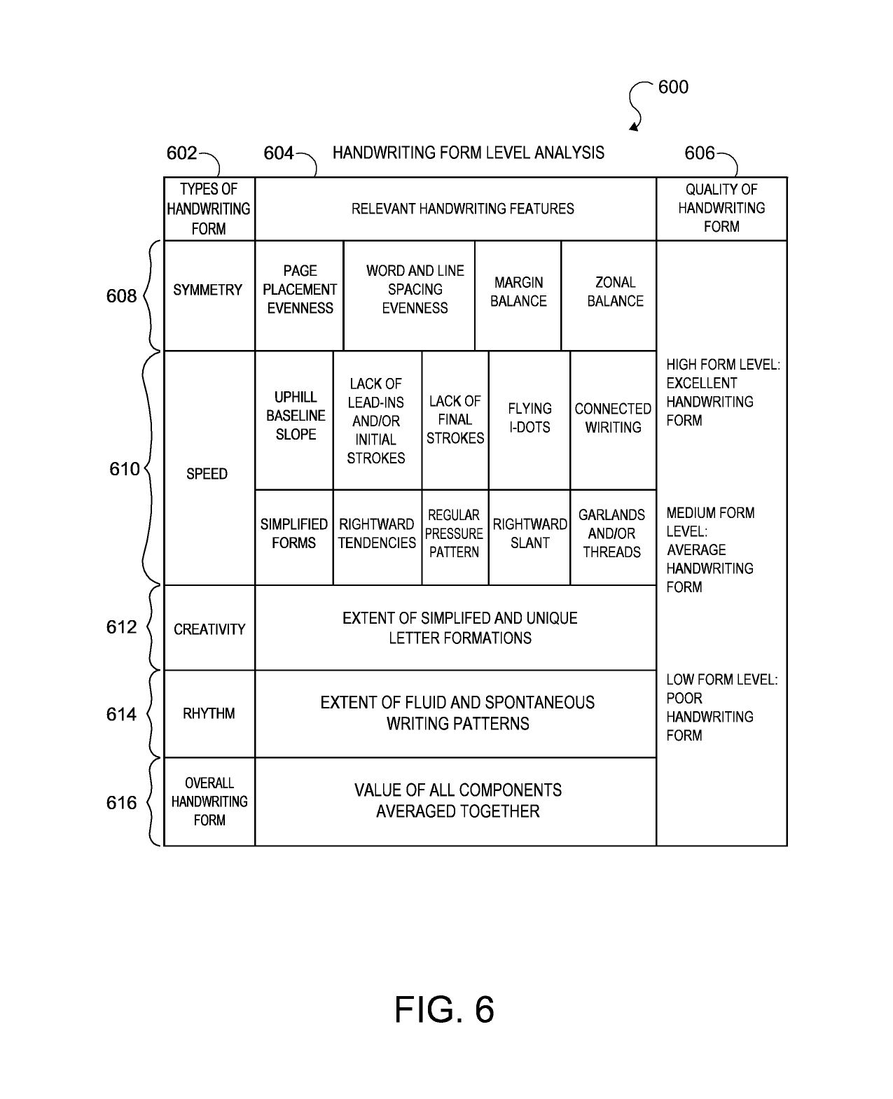

Connective forms, as identified in rows 510, can be interpreted in either a positive light or negative light, depending upon the overall “form level” of an individual's handwriting. Form level is discussed further herein, in connection with FIG. 6. Garlands indicate warmth, caring, and a sympathetic disposition if interpreted positively, but interpreted negatively they can indicate that an individual is smarmy, fake or contrived. Threads can indicate someone who is diplomatic, skilled at negotiation and objectively seeing the big picture in situations, or interpreted negatively they can indicate a pushover or someone who is lazy or indecisive. Angles can indicate someone who is determined, persistent and assertive, or if interpreted negatively, someone who is overly aggressive, controlling or rigid. Arcades can indicate someone who is protective, sentimental, and/or formally courteous in their disposition, or if interpreted negatively, secretive, manipulative and/or scheming.

Pressure in handwriting can be indicative of how driven or easygoing a person is. A person can have light pressure or heavy pressure (or a level of pressure that lies in between those extremes). Level of pressure affects line width, so a measure of applied pressure is the line width of a pen trace, for example, in the number of pixels for scanned handwriting, or carefully measured under magnification in the case of manual processing. In conventional graphology, strong applied pressure may suggest a healthy driving force, a diligence, and/or a strong focus indicating commitment and seriousness, but when interpreted negatively, can indicate impulsiveness, obsession, and/or compulsiveness. Light pressure, on the other hand, can show sensitivity, empathy, and an easygoing, lighthearted, spontaneous and resilient posture if interpreted positively, but can indicate laziness, indecisiveness, or lack of focus if interpreted negatively.

Further examples of predetermined rules of correlation between personal presentation features and handwriting features are as follows. In the upper zone, the upper body from the chest up, these writers will emphasize one or more features of creativity, inventiveness, deep thinking, and anything else originating from the mind. For instance, a person with wild hair like Einstein points to deep thinking and inventiveness and other zone meaning traits as well. Also, upper zone characteristics are seen in the loops of shoelaces when tied. The two loops in a tied pair of laces represents the upper zone. The knot in the middle represents the middle zone and the laces represent the lower zone characteristics. In addition, if the two loops stand out more than the knot or the laces, then it indicates a tendency to the upper zone.

In the middle zone, the overall body, these writers will emphasize a concern about the here and now, a desire for acceptance from others, and daily tasks. For example, these writers have a strong desire for acceptance from other people, they will overall dress in a manner that calls attention to their overall appearance and strictly follow current trends. Many of these writers who crave attention from others often buy expensive brands so others will perceive them and be impressed by their appearance, whereas, Einstein does not necessarily care about how others perceive his appearance (he emphasizes the upper zone rather than the middle zone in his handwriting). The middle zone characteristics are seen in the style of shoes and seen in the knot of tied shoelaces. For example, if the knot in the shoelaces stands out over the loops and laces, then this indicates a tendency to middle zone characteristics described in the zone meaning features.

In the lower zone, the lower body from the waist down, these writers will emphasize physical and sexual energy. In particular, these writers have an abundance of physical and sexual energy, you will often see features standing out in the lower zone such as wearing a color or style of pants that stand out, or wearing vibrant color shoes or sneakers that stand out revealing their tendency to the lower zone. The lower zone characteristics are seen in the shoes as well as in the tied shoelaces. If the laces standout over the loops and knot such as if they are very long or stunted (you do not see the laces at all), then this points to a tendency to the lower zone.

If a writer often dress in lighter colors, is spontaneous, is concerned about the way they look and body language features have a softness and gentleness to it, have a lighter conversation tone, style, and softer voice regarding loudness then the writer is warm, caring, responsive, and sympathetic towards other people. This personality trait maps to the connective form of the garland in handwriting analysis, as has been discussed. Further, these writers will tie their shoelaces with one knot and may often have to re-tie them because the laces come undone.

If a writer often dresses in a mixture of lighter and darker clothing, but their body language displays a protective nature (suspicious look about them), a calculating nature (rigidness), and a sensitive nature (fragile ego) or exhibits an inconsistent conversational tone, style, and loudness of voice then the writer is protective, secretive, calculating, and sensitive. This personality trait maps to the connective form of arcades in handwriting analysis. Further, these writers will tie their shoelaces in a double knot and/or tucking parts or all of the shoelaces under parts of the shoe.

A writer who is aggressive, persistent, determined, and focused will dress in darker clothing and their body language will reveal many dominant characteristics such as a firm and strong look about their eyes, they will often walk with great posture (rigidness), and appear very controlled and disciplined, have a firm handshake, strong conversation tone, style, and loudness of voice (hard) then this writer is aggressive, persistent, determined, and focused. This personality trait maps to the handwriting analysis connective form of angles. Also, with respect to the appearance of their shoelaces these writers will tie their shoelaces with at least a double knot and make the knot very tight (when they tie their shoelaces they will tighten up the knot by pulling the loops so the knot will not come undone).

Lastly, with respect to connective forms, a writer who dresses with a mixture of light and dark clothing, but their body language (the way they approach situations) particularly with resolving issues and being objective will be of notice to these writers and exhibit inconsistent conversation tone, style, and loudness of voice then this writer is diplomatic, sees the big picture, has negotiation and communicative skills, and has indecisiveness. This personality trait maps to the connective form of threads in handwriting analysis. Since threads are a mixture of garlands, arcades and angles, there are no specific ways that these writers tie their shoelaces.

A writer who writes with heavy pressure will also dress in darker clothing and their body language will reveal many dominant characteristics such as a firm and strong look about their eyes, they will often walk with great posture (rigidness), and appear very controlled and disciplined, have a firm handshake, strong conversation tone, style, and loudness of voice (hard). These writers are mentally and physically disciplined, determined, aggressive, active, and persistent. Again, this maps to heavy pressure in handwriting analysis. These writers will tie their shoelaces in a very firm and tight knot so the knot will not later come undone.

A writer who dresses in lighter clothing and their body language reveals passiveness and similar to writers with garlands, this writer is spontaneous, takes time to smell the roses, is passive and easygoing. This personality trait maps to light pressure in handwriting analysis. This writer will display the same characteristics as garland writers regarding shoes and the manner in which their shoelaces are tied.

FIG. 5B illustrates another list 500B of sample presentation features 502 and handwriting features 504 that are associated with personality traits 506. The list 500B is another example of predetermined rules of correlation between personal presentation features and handwriting features. These listed presentation features 502 and handwriting features 504 are categorized as secondary variables. The top secondary variables 512 are the presentation features of living environment and the handwriting feature of spacing of handwriting, followed by the secondary variables 514 of prominence of attire and size of handwriting, followed by the secondary variables 516 of emotional and creative outlets and slant of handwriting, which is followed by the last listed secondary variables 518 of attracting and level of script. As secondary variables, these presentation features 502 and handwriting features 504 are indicative of less inherent or deep-rooted aspects of an individual's personality. These aspects of personality are typically more prone to change than are the aspects of personality indicated by primary variables identified in the list 500A of FIG. 5A.

The spacing of writing can refer to the space between words, as well as between letters. The standard for the use of space between words is the width of one handwritten letter (as written by the individual). Spaces between letters in a word may be of note, particularly if the writing of that word is cramped or expanded compared with the other words in the handwriting. Often the spacing between lines is included in the analysis of handwriting, particularly the sample was written on unlined paper. The secondary variables 512 can indicate the personality traits of an individual's comforts and preferences with and in social environments.

The presentation feature of prominence of attire and the handwriting feature of size of an individual's handwriting indicates their direct and indirect behavior, and their level of introversion or extroversion in direct social interactions. Larger overall size indicates more outgoing behavior, and more relating around people and between people. While smaller size indicates a more reserved and shy nature, and less relating to others.

The next secondary variables listed are the presentation feature of emotional and creative outlets and the handwriting feature of the slant of the handwriting. These features 516 can indicate the extent to which an individual is expressive of their feelings and their inner self in social contexts. A rightward slant indicates more social expression of self, whereas a leftward slant can indicate a more socially introverted mode of expressiveness of self and emotions, such as artistic expression.

Finally, the last listed secondary variables 518 are attracting and the level of script of an individual's handwriting. Whether the handwriting is printed or written in script can indicate significant differences in a subject's willingness to be open and approachable socially. Graphologists often read the level of cursive of a person's handwriting to be a helpful gauge in assessing whether the person is approachable, versus less socially penetrable, or stoic.

All of these presentation features and handwriting features identified in the list 500B are deemed secondary variables according to an embodiment of the present disclosure, and therefore are categorically presumed to point to less deeply-rooted personality traits of a subject, than traits indicated by primary variables as discussed above in connection with FIG. 5A. These traits are therefore to be considered less representative of the individual's inherent personality, than traits indicated by primary variables.

Furthermore, at the same time it should be noted that personality traits expressed dominantly (whether they are primary variables or secondary variables), are deemed to indicate an individual's dominant personality traits, and are therefore taken to indicate more habitually expressed aspects of the individual's personality, than non-dominant traits indicated by non-dominant variables.

Further examples of secondary variables with respect to presentation analysis are identified and discussed as follows. These variables are secondary because they reveal whether a person is introverted and/or extroverted and alludes to many other personality characteristics if there are any extremes in any of the variables, which may reveal psychologically unhealthy combinations. With respect to appearance, an introvert will wear darker clothing, subtle colors (not vibrant colors), were rings on the middle fingers, will wear earrings with a loop that has some sort of design passing through the space in the looped earring (which includes solid circle earrings), and exhibit any other feature that does not attract attention. An extrovert will wear clothing that has vibrant colors or clothing that calls attention, wear rings on the pointer finger and/or the thumb, wear earrings, jewelry, hair style, make-up, and/or any other feature that attracts attention.

With respect to body language, an introvert will not give as much eye contact as an extroverted person, will talk more with the palm of their hands being up, and have more subtle facial expressions/body reaction such as a small smile with other controlled facial features. An extrovert will give eye contact, talk more with the palm of their hands being down, have less subtle facial expressions/body reactions such as a big smile and eye brows raised when greeting someone.

When analyzing how a person ties their shoes or the selection of their shoes, an introvert will have the knot, laces, and loops located on the inner side of the shoe or sneaker, will have more than a double knot, the loops and laces will be too perfect in length (the know will be located directly in the middle of the shoe or sneaker), will tuck a part of the knot, loops, and/or laces in the shoe or sneaker, the loops will be very small and stunted compared to the laces, the laces will be very small and stunted compared to the loops, there will be no initial knot (most people when they tie their shoes or sneakers initially cross the laces and pull and then proceed to finish looping and tying their shoes or sneakers), and will buy shoes and/or sneakers with short laces (may not even realize it, but may avoid buying shoes or sneakers with longer laces). An extrovert will have the knot, laces, and loops located on the outer side of the shoe or sneaker, will have a single or double knot, the loops and laces are spontaneously tied (the laces and loops will not exactly be the same in length), there will be no tucking of any part of the knot, loops, and/or laces, will have substantial relative size between the knot, loops, and laces (none should stand out from the rest), will have an initial knot (most people when they tie their shoes or sneakers initially cross the laces and pull and then proceed to finish looping and tying their shoes or sneakers), will a part of the loops and/or laces skimming the ground as the person walks, will purchase shoes and/or sneakers with long laces (may not even realize it, but may avoid buying shoes or sneakers with shorter laces).

Further examples of secondary variables with respect to handwriting analysis are identified and discussed as follows. These variables are secondary because they reveal whether a person is introverted and/or extroverted. The variable space in handwriting includes margins, space between letters, words, and lines, and baseline direction and other features as well. The margins of an introverted person have a narrow left margin, the left margin progressively narrows, wide margins all around, funnel margin, wide right margin, and the right margin progressively widens. While the margin of an extroverted person will have a narrow right margin, a wide left margin, narrow margins all around, balanced margins, the left margin progressively widens, and the right margin progressively narrows. The space between letters for an introverted person will be narrow. While the space between letters for an extroverted person will be wide. There will be wide spaces between words for an introverted person and narrow spaces between words for an extroverted person. The space between lines for an introverted person will be wide. An extroverted person will have a narrow space between lines. With respect to baseline direction, an introverted person will have a rigid baseline, a sinuous baseline, a descending baseline, and a stepped down baseline. The baseline direction of an extroverted person will have a stable baseline, a flexible baseline, an ascending baseline, and a stepped up baseline.

The variable size of handwriting includes the total size in millimeters of the handwriting and the size of the capital letters. The handwriting size of an introverted person will be small and the size of the capital letters will be small. On the other hand, the handwriting size of an extroverted person will be large and the size of the capital letters will be large.

The slant of handwriting, leftward or rightward, will indicate whether a person is an introvert or an extrovert. For example, an introvert will have handwriting slanted to the left while an extrovert will have handwriting slanted to the right. Also, compressed letters or words indicate leftward tendencies which would show that the person is an introvert. Loss of legibility of handwriting indicates rightward tendencies which the handwriting of an extrovert would exhibit.

The variable cursive/printing of handwriting includes cursive, print, or a mix of the two forms. An introverted person will print and an extroverted person will use cursive writing. A mixture of cursive and printing will also tend to indicate whether a person is an introvert or an extrovert.

With particular reference now to FIG. 6, a chart 600 depicts categories 602 and handwriting features 604 that are assessed to determine an individual's overall handwriting form level 606, which can impact how other aspects of the individual's handwriting are interpreted. The form level 606 of the handwriting can be defined, informally, as an overall impression given by the handwriting. In some embodiments, applying a form level analysis can provide an indication of the social healthiness of an individual's personality, thereby enhancing interpretation of the individual's handwriting features so as to aid in determining the individual's personality traits.

Form level 606 includes how the writing flows, that is, whether the handwriting seems fluid or broken. Form level 606 can also include other attributes such as overall legibility, symmetry 608, speed 610, creativity 612, and even rhythm 614 of the handwriting. In conventional graphology, high form level represents a high overall impression of the handwriting, while low form designates an overall low impression of the handwriting. It will be appreciated that form level can also be applied to the overall impression of an individual handwritten word.

Form level 606 has four main components, the first one of which is symmetry 608. Symmetry 608 sheds light on an individual's internal organization, represented by the evenness and balance in their handwriting. The individual's personality, as interpreted by other variables, will be interpreted through the lens of their form level.

In the case of the form level component of symmetry 608, this is done by deducing from the symmetry score, whether they are mentally organized and methodical towards their goals, whether they have psychological and emotional balance, how they cope with stress, and whether there is consistency in their psychological and emotional behavior. Symmetry 608 can be given a score based on such factors as the evenness of the individual's placement of their writing on a page, the evenness of their word (and/or letter), and/or line spacing, their margin balance, and the balance of their zones.

The second main component of form level is speed 610, which sheds light on an individual's ability to process information. This can be helpful in indicating whether a subject can employ on-the-spot thinking, and can process information efficiently and productively. Speed 610 can be given a score based on such factors as the slope of their writing, presence or lack of lead-ins or long initial strokes at word beginnings, presence or lack of final strokes at word endings, connectedness of writing, simplified form of writing, pressure pattern, slant, and presence or lack of garlands and/or threads.

The third main component of form level is creativity 612, which sheds light on an individual's leadership quality, and their uniqueness and efficiency of thought and character. An individual with a high creativity score, for example, is deemed to be thinking based truly on an efficient, unique, innovative and completely objective thought process, rather than being unduly influenced by societal norms. Creativity 612 also indicates an ability to “break from the mold” in an efficient and productive way, to rise above outdated ways of doing things, and to see more beneficial solutions to dilemmas. Therefore, creativity is assessed by observing the extent to which letter formations are uniquely crafted in a simplified way. This indicates the individual has crafted their own unique way of writing efficiently, having moved beyond the precise rules of writing and letter formation to a new system of letter formations that is more efficient for them.

The fourth and last main component of form level is rhythm 614, which indicates an individual's ability to accomplish tasks in an efficient manner. In contrast to a rigid affect, an individual with high form level in the rhythm category will have a certain fluency and economy in their approach to problems and to life. Rhythm 614 is indicated by expansive handwriting, consistent pressure, a bouncy flow to the writing, and fluid and spontaneous writing patterns.

These four main components 608, 610, 612, and 614 can then be averaged together to obtain an average overall form level 616. An individual's form level will typically stay with them into adulthood, except if and when faced with significant or somewhat life-changing events or challenges.

Someone with excellent form level may be more efficient than one with average form level, but they may be vulnerable. If a big tragedy strikes, an untested individual with high form level regresses into poor form level. But if they work themselves through the problem, they have learned resilience and they will probably stay there with a new strength and solidity.

The person with a stable equilibrium of high form level would be considered to have resilient high form level. Someone with high form level who is susceptible to falling apart in the face of large challenges they have yet to face, would be considered to be in a state of dynamic equilibrium and therefore non-resilient form level. Resilience and stability is another important aspect of assessing form.

The individual with resilient high form level is deemed to be closer to being a “self-actualized” person (to use the term from Maslow's Hierarchy), not likely to be compromised or to regress. High form level leads to other handwriting features (such as primary and secondary features, dominant and non-dominant features) to be interpreted in a more positive light, rather than being viewed through a more negative lens, as in the case of someone with poor form level.

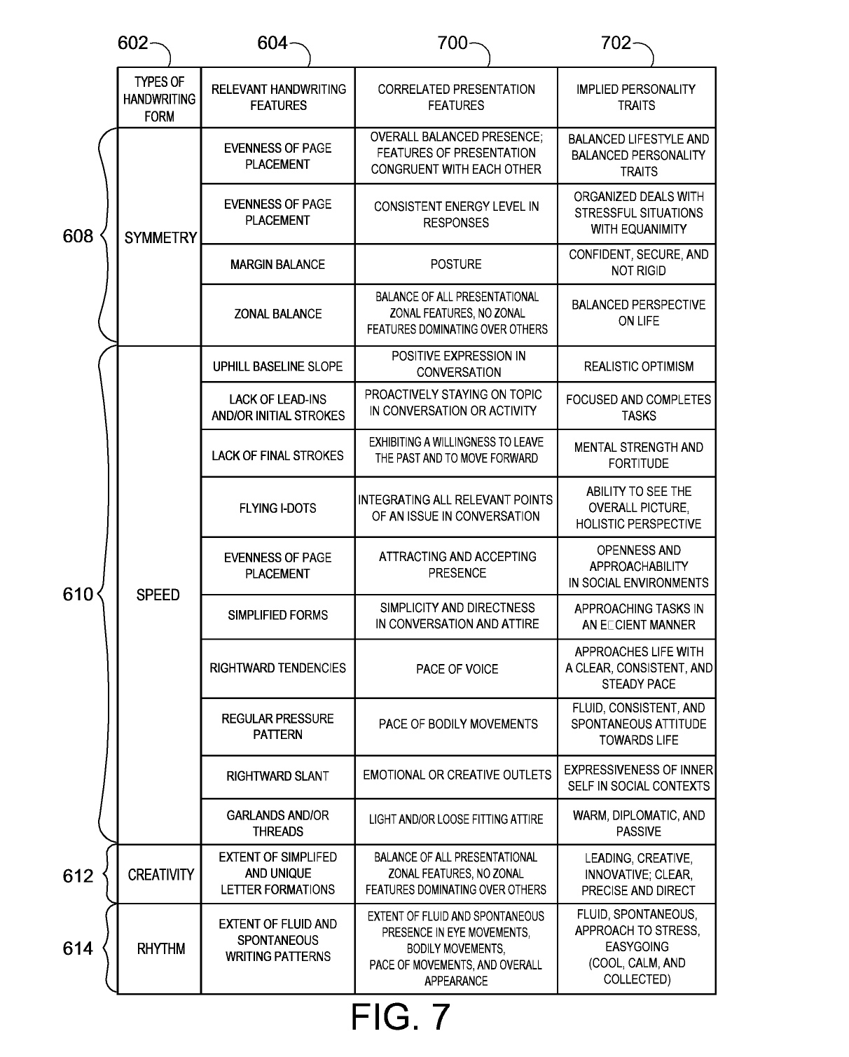

FIG. 7 is a chart listing categories 602, presentational features 700, and handwriting features 604 that correlate to particular personality traits 702. The categories 602 include the four main components for form level which were previously discussed which are symmetry 608, speed 610, creativity 612, and rhythm 614. The chart is an example of predetermined rules of correlation between personal presentation features and handwriting features.

With respect to the component of symmetry 608, the presentational feature 700 of overall balance presence is combined with the handwriting feature 604 of evenness of page placement to correlate to the personality trait 702 of balanced lifestyle and balanced personality trait. The presentational feature 700 of consistent energy level in responses is combined with the handwriting feature 604 of evenness of word and line spacing to correlate to the personality trait 702 of organized deals with stressful situations with equanimity. The presentational feature 700 of posture is combined with the handwriting feature 604 of margin balance to correlate to the personality trait 702 of confidant, secure, and not rigid. The last presentational feature 700 in the symmetry category 608 is balance of presentational zonal features which is combined with the handwriting feature 604 of zonal balance to correlate to the personality trait 702 of balanced perspective on life.

In the speed category 610, the presentational feature 700 of positive expression in conversation is combined with the handwriting feature 604 of uphill baseline slope to correlate to the personality trait 702 of realistic optimism. The next presentational feature 700 in the speed category 610 is proactively staying on topic in conversation or activity. This presentational feature 700 is combined with the handwriting features 604 of lack of lead-ins and/or initial strokes. These two features correlate to the personality trait 702 of focused and completes tasks. Exhibiting willingness to leave the past and to move forward is the next presentational feature 700. This feature is combined with the handwriting feature 604 of lack of final strokes to correlate to the personality trait 702 of mental strength and fortitude. Next, the presentational feature 700 of integrating all relevant points of an issue in conversation is combined with the handwriting features 604 of flying i-dots to correlate to the personality traits 702 of ability to see the overall picture and holistic perspective. Attracting and accepting presence is the next presentational feature 700 in the speed category 610. This feature is combined with the handwriting feature 604 of connected writing to correlate to the personality traits 702 of openness and approachability in social environments. The presentational features 700 of simplicity and directness in conversation and attire are combined with the handwriting feature 604 of simplified forms to correlate to the personality trait 702 of approaching tasks in an efficient manner. Pace of voice is the next presentational feature 700 that is combined with the handwriting feature 604 of rightward tendencies which correlate to the personality trait 702 of approaches life with a clear, consistent, and steady pace. The presentational feature 700 of pace of bodily movements is combined with the handwriting feature 604 of regular pressure pattern. The two features correlate to the personality traits 702 of fluid, consistent, and spontaneous attitude toward life. The next presentational feature 700 in the speed category 610 is emotional or creative outlets. This is combined with the handwriting feature 604 of rightward slant to correlate to the personality trait 702 of expressiveness of inner self in social contexts. The last presentational feature 700 in the speed category 610 is light and/or loose fitting attire. This particular presentational feature 700 is combined with the handwriting feature 604 of garlands and/or threads to correlate to the personality traits 702 of warm, diplomatic, and passive.

The category of creativity 612 has the presentational feature 700 of extent of unique and simplified presence in both appearance and verbal and non-verbal cues, which is combined with the handwriting feature 604 of extent of simplified and unique letter formations. These features correlate to the personality traits 702 of leading, creative, innovative, clear, precise, and direct.

The last category shown in FIG. 7 is the category of rhythm 614. In the rhythm category 614 are the presentational features 700 of extent of fluid and spontaneous presence in eye movements, body movements, pace of movements, and overall appearance. These personality features 700 are combined with the handwriting features 604 of extent of fluid and spontaneous writing patterns to correlate to the personality traits 702 of fluid, spontaneous, approach to stress, and easygoing (cool, calm, and collected).

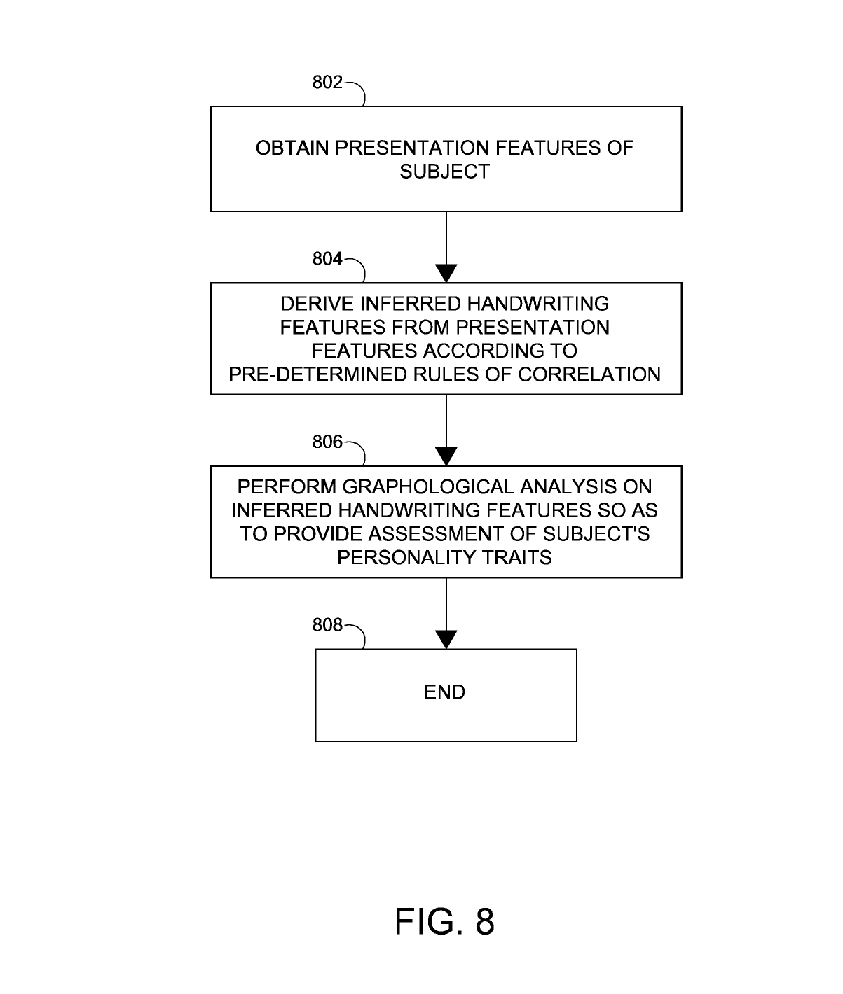

Turning now to FIG. 8, a flowchart diagram 800 which details the steps taken to assess an individual's personality in accordance with an embodiment of the present disclosure is shown. In a first step 802 predetermined rules of correlation between personal presentation features and handwriting features are provided. In a next step 804, information concerning personal presentation features of an individual or a subject is obtained. As has been discussed above, such personal presentation features may include shape of the head, neck, and shoulders, shape of the torso, shape of the lower body and legs, color of clothing, and looseness or tightness of clothing. Also, secondary personal presentation features such as living environment, prominence of attire, emotional and creative outlets, and attracting and accepting presence may be viewed and used. After step 804 a next step 806 is encountered. In the step 806 there is a correlation of the personal presentation features with inferred handwriting features by use of the rules of correlation which were predetermined in the step 802. In the step 806, there is a conversion of presentation analysis into handwriting analysis by use of the predetermined rules of correlation. As indicated above, handwriting analysis already includes a methodical approach for determining aspects of personality. After step 806, there is an analysis of inferred handwriting features so as to generate inferred handwriting feature data, as is shown in a step 808. Once analyzed, there is an assessment of an individual's personality using graphology-based analysis of inferred handwriting feature data in a last step 810. In this manner, more personality traits may be detected than if only handwriting analysis is performed or used. In particular, an amateur or inexperienced graphologist may miss or fail to detect certain personality traits from only using handwriting analysis. By use of the method steps 802, 804, 806, 808, and 810, more personality traits will be detected and not missed. It is also contemplated and possible that handwriting analysis may be converted into presentation analysis to enable handwriting analysis to be related to presentation analysis. In this manner, more personality traits may be detected than if only presentation analysis is being used or performed. In this particular case, an amateur or inexperienced person using presentation analysis may miss or fail to detect certain personality traits from only using presentation analysis. Again, an enhanced assessment of an individual may be performed by the combination of presentation analysis and handwriting analysis.

Other modifications and implementations will occur to those skilled in the art without departing from the spirit and the scope of the invention as claimed. Accordingly, the above description is not intended to limit the invention, except as indicated in the following claims.

What is claimed is:

1. A method for graphology-based assessment of personality traits of a subject, the method comprising:
obtaining presentation features of the subject;
deriving inferred handwriting features from the presentation features according to pre-determined rules of correlation between the presentation features and the inferred handwriting features; and
performing graphological analysis on the inferred handwriting features so as to provide an assessment of the subject's personality traits.

2. The method of claim 1, wherein obtaining presentation features includes observing at least one of:
the subject's general appearance;
the subject's personal attire;
the subject's hair style;
the subject's body language;
the subject's facial expression;
the subject's handshake;
the subject's conversational tone; and
the subject's conversational style.

3. The method of claim 1, wherein obtaining presentation features includes:
observing an upper zone of the subject's body;
observing a middle zone of the subject's body; and
observing a lower zone of the subject's body.

4. The method of claim 1, wherein deriving inferred handwriting features from the presentation features includes:
mapping information regarding at least one of upper, middle, and lower zones from the presentation features, to at least one of corresponding upper, middle, and lower zones of the inferred handwriting features being derived from the presentation features.

5. The method of claim 1, wherein deriving inferred handwriting features includes:
deriving from the presentation features at least one of primary variables and secondary variables.

6. The method of claim 5, wherein the primary variables include:
zonal sizes of handwriting;
connective forms of handwriting including garlands, arcades, angles, and threads; and
pressure applied during handwriting.

7. The method of claim 5, wherein the secondary variables include:
spacing of writing;
size of writing;
slant of writing; and
level of script.

8. The method of claim 1, wherein performing graphological analysis on the inferred handwriting features so as to provide an assessment of the subject's personality traits includes:
determining handwriting form level based upon the inferred handwriting features.

9. A method for graphology-based assessment of personality traits of a subject, the method comprising:
obtaining presentation features of the subject;
deriving inferred handwriting features from the presentation features, according to
pre-determined rules of correlation between the presentation features and the inferred handwriting features;
identifying actual handwriting features from a real sample of the subject's handwriting; and
performing graphological analysis on:
the inferred handwriting features; and
the actual handwriting features,
so as to provide an assessment of the subject's personality traits.

10. The method of claim 9, wherein obtaining presentation features includes observing at least one of:
the subject's general appearance;
the subject's personal attire;
the subject's hair style;
the subject's body language;
the subject's facial expression;
the subject's handshake;
the subject's conversational tone; and
the subject's conversational style.

11. The method of claim 9, wherein obtaining presentation features includes:
observing an upper zone of the subject's body;
observing a middle zone of the subject's body; and
observing a lower zone of the subject's body.

12. The method of claim 9, wherein deriving inferred handwriting features from the presentation features includes:
mapping information regarding at least one of upper, middle, and lower zones from the presentation features, to at least one of corresponding upper, middle, and lower zones of the inferred handwriting features being derived from the presentation features.

13. The method of claim 9, wherein deriving inferred handwriting features includes:
deriving from the presentation features at least one of primary variables and secondary variables.

14. The method of claim 13, wherein the primary variables include:
zonal sizes of handwriting;
connective forms of handwriting including garlands, arcades, angles, and threads; and
pressure applied during handwriting.

15. The method of claim 13, wherein the secondary variables include:
spacing of writing;
size of writing;
slant of writing; and
level of script.

16. The method of claim 9, wherein performing graphological analysis on:
the inferred handwriting features; and
the actual handwriting features,
so as to provide an assessment of the subject's personality traits, includes:
determining handwriting form level, based upon the inferred handwriting features.
